(19) United States
(12) Patent Application Publication
(10) Pub. No.: US 2003/0074213 A1
(43) Pub. Date: Apr. 17, 2003

(54) Address data management method and address data management system

(75) Inventors: Masahiko Murakami, Kawasaki (JP); Sumiyo Okada, Kawasaki (JP); Takashi Ohno, Kawasaki (JP); Jun Kakuta, Kawasaki (JP); Yasuhide Matsumoto, Kawasaki (JP); Shingo Fujimoto, Kawasaki (JP); Hideto Kihara, Kawasaki (JP); Masayuki Fukui, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/056,089

(22) Filed: Jan. 28, 2002

(30) Foreign Application Priority Data
Oct. 16, 2001 (JP) 2001-318217

(51) Int. Cl. G06F 17/60

(52) U.S. Cl. 705/1

(57) ABSTRACT

An address data management method and system that allow a purchaser wishing to purchase merchandise from an online shopping site on the Internet or other vendor to make a purchase and request delivery while keeping address data comprising delivery address secret from third parties, including the vendor of that merchandise. An address data management method comprises the steps of: acquiring address data comprising delivery address from a purchaser; establishing an address ID with unique correspondence to address data and notifying the purchaser thereof; managing a correspondence table indicating correspondence between address data and address ID; accepting delivery request data generated by the merchandise vendor; extracting address data corresponding to address ID; and executing delivery processing of the article based on the extracted address data.

### BACKGROUND OF THE INVENTION

1. Technical Field

The present invention relates to an address data management method and system for delivery addresses when merchandise and delivery thereof is ordered from a vendor.

2. Description of Related Art

With the recent growth of the Internet, a great variety of sites now exist, with many of them offering online shopping. A person at home using these sites can purchase and have delivered to his own home not only computers, books and other technically oriented articles, but also household goods, specialty products from different localities, foodstuffs and other general merchandise for use at home.

When merchandise is purchased at such an online shopping site, with the exception of some software, the purchased merchandise is generally delivered by a delivery company. The purchaser of the merchandise inputs his address onto a prescribed online form transmitted from an online shopping site, thereby making a purchase and requesting delivery of the merchandise.

Thus a purchaser entrusts a very important piece of personal information-namely, his address-to this online shopping site. If the entity operating the site happens to be not entirely scrupulous, this information may be sold to makers of databases for direct mailers, resulting in a flood of direct mailings being sent to the purchaser's address.

Even if the site operator is itself not dishonest, there is the danger that a third party may gain unauthorized access to the site and steal personal information. Thus experienced Internet users are aware of the possibility that personal information can get divulged and are therefore reluctant to use online shopping sites; this in turn may very well lead to a decrease in the number of users of online shopping sites.

In order to encourage continued use by purchasers, operators of online shopping sites take efforts to assure purchasers that they are not dishonest, and they also must make efforts, for example, to heighten security, so that the personal information that purchasers entrust them with is not divulged. Thus they are forced to expend significant costs other than those involved in making sales.

In addition, despite the fact that it is the delivery company delivering the merchandise that actually connects an online shopping site and purchaser, the delivery company only performs the task of receiving the order for delivery from the site and then making delivery; the delivery is unable to treat the purchaser as its own client and provide special services, even if that purchaser is a frequent user.

### SUMMARY OF THE INVENTION

The present invention proposes an address data management method and system that allow a purchaser wishing to purchase merchandise from an online shopping site and other vendors to make a purchase and order delivery while keeping the address data for the delivery address secret from third parties, including the seller of the merchandise.

An address data management method of the present invention comprises the steps of; acquiring address data from a purchaser wishing to purchase and have merchandise delivered, the address data comprising delivery address; establishing a unique address ID for the address data, the address ID being invulnerable to reverse translation by a third party into the address data, and notifying the purchaser thereof; managing a correspondence table indicating correspondence between the address data and address ID; accepting delivery request data generated by a vendor of the merchandise based upon a delivery request from the purchaser, the purchaser having given the address ID as delivery address; looking up the address ID in the delivery request in the correspondence table, and extracting corresponding address data; and executing delivery processing of the article based on the extracted address data.

A second aspect of the present invention provides an address data management method according to the first aspect, wherein at the elapse of a set length of time following establishment of the address ID, the corresponding address ID in the correspondence table is deleted.

A third aspect of the present invention provides an address data management method according to the first aspect, wherein an address ID corresponding to address data for which delivery processing has been executed a predetermined number of times is deleted from the correspondence table.

A fourth aspect of the present invention provides an address data management method according to the third aspect, wherein an address ID corresponding to address data for which delivery processing has been executed once is deleted from the correspondence table.

A fifth aspect of the present invention provides an address data management method according to the first aspect. The method further includes the step of accepting from the purchaser instructions to make the address ID invalid, and deleting the corresponding address ID in the table.

A sixth aspect of the present invention provides an address data management method The method comprises the steps of: acquiring address data from a purchaser wishing to purchase and have merchandise delivered, the address data comprising delivery address; establishing a unique user account for identifying the purchaser and notifying the purchaser thereof; managing a correspondence table showing the correspondence between the address data and user accounts; in response to an inquiry from a vendor of merchandise that the purchaser wishes to purchase and have delivered, authenticating the purchaser using the purchaser's user account, establishing an address ID invulnerable to reverse translation to the address data by a third party, and notifying the vendor of the address ID; accepting delivery request data generated by a vendor of the merchandise that includes the address ID; executing delivery processing of the article based on address data corresponding to the address ID.

A seventh aspect of the present invention provides an address data management method according to the sixth aspect. The method further comprises the steps of: computing use points for the user account each time delivery processing is executed; and awarding benefits to the user account based on the accumulated total of the use points.

A eighth aspect of the present invention provides an address data management method according to the sixth aspect. The method further comprises the step of transferring the delivery request data to the purchaser when delivery request data has been received from the vendor, and accepting confirmation information from the purchaser.

A ninth aspect of the present invention provides an address data management method according to the sixth aspect. The method further comprises the step of determining whether the address ID included in delivery request data received from the vendor is valid, and deciding whether to execute delivery processing of the article based on the results of the determination.

A tenth aspect of the present invention provides an address data management method according to the sixth aspect. The method further comprises the step of setting up benefits in advance to award to the vendor each time delivery request data is received from the vendor.

An eleventh aspect of the present invention provides an address data management method according to the sixth aspect. The method further comprises the steps of: acquiring information relating to settlement method by the purchaser; and settling accounts with the vendor based on information relating to settlement method upon receipt of delivery request data from the vendor.

A twelfth aspect of the present invention provides an address data management system. The system comprises: address data acquisition means for acquiring address data from a purchaser wishing to purchase and have merchandise delivered, the address data comprising delivery address; address ID establishment means for establishing a unique address ID for the address data, the address ID being invulnerable to reverse translation by a third party into the address data, and notifying the purchaser thereof; correspondence table management means for managing a correspondence table indicating correspondence between the address data and address ID; delivery request acceptance means for accepting delivery request data generated by a vendor of the merchandise based upon a delivery request from the purchaser, the purchaser having given the address ID as delivery address; delivery processing means for looking up the address ID in the delivery request in the correspondence table, extracting the corresponding address data, and executing delivery processing of the article based on the extracted address data.

A thirteenth aspect of the present invention provides an address data management system method according to the twelfth aspect, wherein the correspondence table management means deletes the corresponding address ID in the correspondence table when a set length of time has elapsed following establishment of the address.

A fourteenth aspect of the present invention provides an address data management system according to the twelfth aspect, wherein the correspondence table management means deletes an address ID corresponding to address data for which delivery processing has been executed a predetermined number of times.

A fifteenth aspect of the present invention provides an address data management system according to the twelfth aspect, wherein the correspondence table management means deletes an address ID corresponding to address data for which delivery processing has been executed once.

A sixteenth aspect of the present invention provides an address data management system according to the twelfth aspect, wherein the correspondence table management means accepts from the purchaser instructions to make the address ID invalid, and deletes the corresponding address ID in the table.

A seventeenth aspect of the present inventio provides an address data management system. The system comprises: address data acquisition means for acquiring address data comprising delivery address from a purchaser wishing to purchase and have merchandise delivered; user account establishment means for establishing a unique user account for identifying the purchaser and notifying the purchaser thereof; correspondence table management means for managing a correspondence table indicating correspondence between the address data and user account; address ID establishment means for, in response to an inquiry from a vendor of merchandise that the purchaser wishes to purchase and have delivered, authenticating the purchaser using the purchaser's user account, establishing an address ID invulnerable to reverse translation to the address data by a third party, and notifying the vendor of the address ID; delivery request acceptance means for accepting delivery request data generated by a vendor of the merchandise, that includes the address ID; and delivery processing means for executing delivery processing of the article based on address data corresponding to the address ID.

An eighteenth aspect of the present invention provides an address data management system according to the seventeenth aspect. The system further comprises: use point management means for adding use points for the user account each time delivery processing is executed; and benefit presentation means for awarding benefits to the user account based on the accumulated total of the use points.

A ninteenth aspect of the present invention provides an address data management system according to the seventeenth aspect. The system further comprises request confirmation means for transferring the delivery request data to the purchaser when delivery request data has been received from the vendor, and accepting confirmation information from the purchaser.

A twentieth aspect of the present invention provides an address data management system according to the seventeenth aspect. The system further comprises address ID determination means for determining whether the address ID included in delivery request data received from the vendor is valid, and deciding whether to execute delivery processing of the article based on the results of the determination.

A twenty-first aspect of the present invention provides an address data management system according to the seventeenth aspect. The system further comprises vendor benefit establishment means for establishing benefits in advance to award to the vendor each time delivery request data is received from the vendor.

A twenty-second aspect of the present invention provides an address data management system according to the seventeenth aspect. The system further comprises: settlement information acquisition means for acquiring information relating to settlement method from the purchaser; and settlement means for settling accounts with the vender based on information relating to the settlement method, upon receipt of delivery request data from the vendor.

From the following detailed description in conjunction with the accompanying drawings, the foregoing and other objects, features, aspects and advantages of the present invention will become readily apparent to those skilled in the art.

### BRIEF DESCRIPTION OF THE DRAWINGS

FIG. 1 is a diagram illustrating the overall configuration of the present invention;

FIG. 2 is a diagram illustrating processing when a user account is issued;

FIG. 3 is a diagram illustrating a table in the user account database;

FIG. 4 is a diagram illustrating a merchandise purchase confirmation screen;

FIG. 5 is a diagram illustrating an address ID issue request screen;

FIG. 6 is a diagram illustrating an issue address ID screen;

FIG. 7 is a diagram illustrating issue address ID processing;

FIG. 8 is a diagram illustrating a table in the issued address ID database;

FIG. 9 is a diagram illustrating a new user registration screen;

FIG. 10 is a diagram illustrating an issue user account screen;

FIG. 11 is a diagram illustrating delivery request processing;

FIG. 12 is a flowchart of delivery processing;

FIG. 13 is a diagram illustrating a limited term address ID table;

FIG. 14 is a flowchart of delivery processing in the case of one-time use address Ids;

FIG. 15 is a diagram illustrating a table in the use history database;

FIG. 16 is a flowchart of free benefit processing;

FIG. 17 is a diagram illustrating a table in the delivery history database; and

FIG. 18 is a flowing chart of refund to vendor processing.

### DETAILED DESCRIPTION OF THE PREFERRED EMBODIMENTS

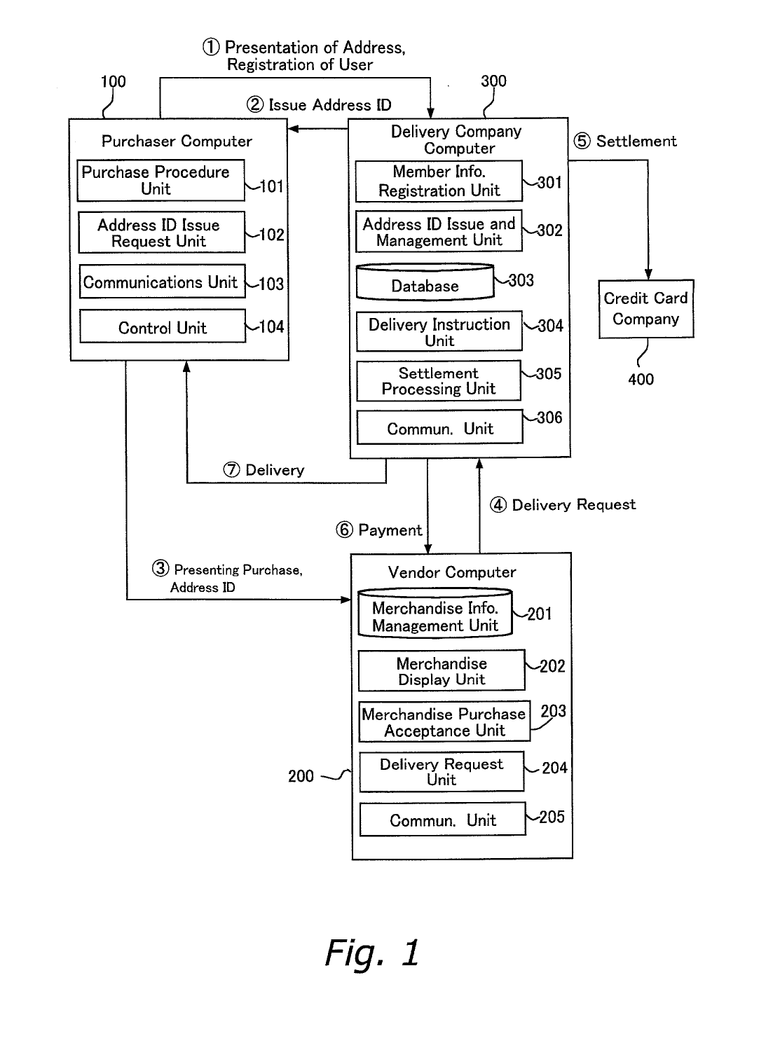

A summary of the configuration of the address data management system according to a first embodiment of the present invention is shown in FIG. 1.

In this instance, a vendor operates an online shopping site on the Internet, and a purchaser wishing to order the purchase and delivery of merchandise handled at this site requests a delivery company to deliver the merchandise to his home.

The following devices can interconnect with each other over a network: a computer device 200 that a vendor uses for the operation of its online shopping site, a computer 300 that a delivery company uses for managing delivery of merchandise to be delivered and for the issuing and managing of address IDs associated with delivery addresses in response to requests from users, a computer 100 that a purchaser users to connect with the online shopping site and carry out merchandise purchase procedures, and to connect with the delivery company computer to acquire an address ID, and a computer 400 for a credit card company that processes the settlement of the purchase transaction.

To facilitate the explanation, only one each of the computers 100, 200, 300 and 400 is shown in the figure; however, it goes without saying that a plurality of any of these may exist.

The computer 100 used by a purchaser has a communications unit 103 for communicating with other computers over a network; a control unit 104 for controlling a display device and the like; a merchandise purchase processing unit 101 for connecting to an online shopping site and performing the procedures for merchandise purchase, and an address ID issue request unit 102 for requesting the issue of an address ID to be used in place of a delivery address.

The computer 200 used by the vendor has a communications unit 205 for communicating with other computers over a network, as well as a merchandise information management unit 201 for managing information relating to merchandise handled; a merchandise presentation unit 202 for presenting merchandise information to a purchaser computer based on merchandise information stored in the merchandise information management unit 201 upon request from the purchaser computer; a merchandise purchase acceptance unit 203 for accepting requests for purchase of merchandise from the purchaser computer 100; and a delivery request unit 204 for making request to the delivery company computer 300 for delivery of merchandise.

The delivery company computer 300 has a communications unit 306 for communicating with other computers over a network, as well as a member information registration unit 301 for accepting registration information from the purchaser computer 100 and performing registration of member information; an address ID issuing and management unit 302 for issuing address IDs upon request from the purchaser computer 100; a database 303 for managing member information and information relating to address ID; a delivery instruction unit 304 for determining the validity of an address ID transmitted from the vendor computer 200 along with information relating to merchandise to be delivered, acquiring, when the address ID is valid, the actual address that corresponds to the address ID, and giving instructions for merchandise delivery; and a settlement processing unit 305 for processing settlement when settlement processing instructions have been transmitted from the vendor computer 200 along with information relating to merchandise to be delivered.

In the explanation to follow, the computer 100 used by a purchaser shall be referred to as “purchaser 100”, the computer 200 used by the vendor, “vendor 200”, the computer 300 used by the delivery company, as “delivery company 300”, and the computer 400 used by the credit company as “credit card company 400.”

A purchaser 100 first uses the address ID issue request unit 102 to present a delivery company 300 with address data, this address data being the delivery address. For example, the purchaser 100 accesses a website on the Internet operated by the delivery company 300, and transmits his name, address, email address, and other personal information, as well as address data, i.e., the delivery address for the merchandise (#1 in FIG. 1). When the purchaser 100 selects settlement processing by the 300, he selects settlement means, for example, in the case of payment by credit card, the purchaser 100 sends his credit card number. When the purchaser 100 is to register as a member at a site operated by the delivery company 300, he sends notification to that effect.

The address ID issue and management unit 302 of the delivery company 300 receives personal information of the purchaser 100 and the address data, i.e., the delivery address, establishes an address ID that uniquely corresponds to the address data (i.e., the delivery address) and cannot be translated into address data by a third party, and sends this to the purchaser 100 (#2 on FIG. 1). This address ID may be constituted so that, each time there is a request from the purchaser 100, an ID address corresponding to the address data (i.e., the address to which merchandise is to be delivered) is issued. The delivery company 300 manages the database 303 in which address IDs and delivery address data are associated, and it updates the database 303 when an address ID is issued. In cases where a membership system is used, the member identification code and information inputted by the purchaser 100 are registered in the database 303 as member information.

In cases where the purchaser 100 shops at a online shopping site operated by a vendor 200 on the Internet, the purchaser 100 accesses the site using a merchandise purchase procedure unit 101 (which may be a browser), and orders the purchase of merchandise. When the purchaser 100 desires delivery of the merchandise by the delivery company 300, he designates the delivery company 300 as the delivery company, and notifies the vendor 200 of the delivery address information, which gives the address ID as the address for delivery of the merchandise (#3 on FIG. 1).

The delivery request unit 204 of the vendor 200 accepts delivery address information from the purchaser 100, and sends to the delivery company 300 delivery request data (#4 on FIG. 1). This delivery request data includes the address ID received from the purchaser 100. The delivery instruction unit 304 of the delivery company 300 refers to the database 303 and identifies the purchaser 100 corresponding to this address ID and identifies the address data (i.e., the delivery address).

When the purchaser 100 wishes to have the delivery company 300 perform settlement processing by credit card, settlement processing is performed by the settlement processing unit 305 with the credit card company 400, using the credit card number given by the purchaser 100 (#5 on FIG. 1). Further, the delivery company 300, based on the results of this settlement, makes payment for the merchandise to the vendor 200 (#6 on FIG. 1).

The delivery company 300 also refers to the database, extracts address data corresponding to the address ID, and performs delivery processing of the merchandise the purchaser 100 purchased to the corresponding delivery address (#7 on FIG. 1).

The system may be configured so that each time the purchaser 100 wishes to purchase merchandise and have it delivered, he notifies the delivery company 300 of his address data and requests the issue of an address ID. It may also be configured so that the purchaser 100 undergoes user registration by notifying the delivery company 300 of his personal information and address data (i.e., delivery address).

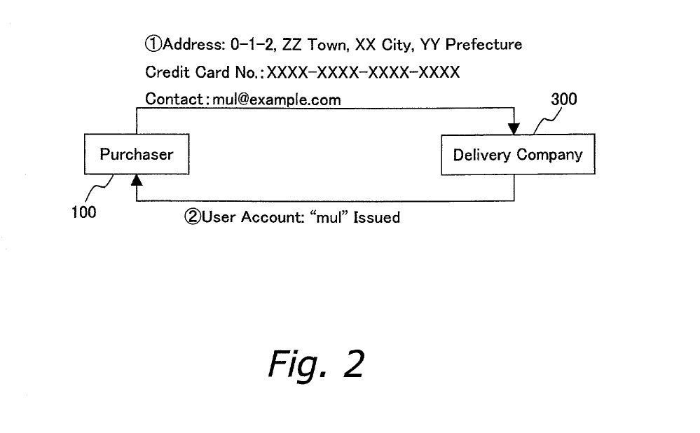

When the purchaser 100 wishes to undergo user registration with the delivery company 300, as shown in FIG. 2, the purchaser 100 notifies the delivery company 300 of his address, name, email address and other personal information, as well as address data (i.e., delivery address) (#1 on FIG. 2). At this time, if the purchaser 100 wishes to have the delivery company 300 perform settlement processing, the purchaser 100 also notifies the delivery company 300 of information relating to the settlement means, such as credit card number.

The delivery company 300, when it has received from the purchaser 100 a notification to the effect that user registration is desired, sets up a user account (e.g., mul) corresponding to the personal information of the purchaser 100, and gives notification thereof to the purchaser 100 (#2 on FIG. 2).

The delivery company 300 updates the user account database, where personal information and address data received from the purchaser 100 have been corresponded with the user account set up for the purchaser 100.

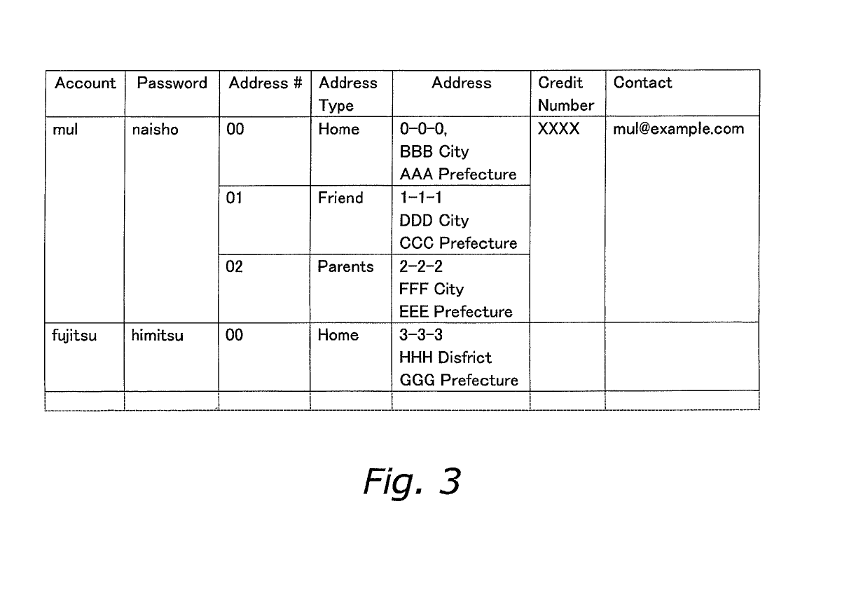

FIG. 3 shows one possible configuration for a user account database table.

The correspondence table shown in FIG. 3 has columns for account, password, address number, address type, address, credit number, contact information, etc. The account column contains established user accounts. The password column contains passwords that the delivery company 300 has assigned purchasers 100 or passwords selected by purchasers 100. In cases where a plurality of delivery addresses have been entered for a single user account, an address number is assigned to each delivery address entry, and the address type is identified, as in whether a home address or other sort of address; these are stored in the address number and address type columns, respectively. The address column contains the address data for the address to which merchandise is to be delivered. In cases where the purchaser 100 asks the delivery company 300 to process settlement by credit card, a credit card number of the purchaser 100 is contained in the credit number column and managed therein. The contact information column contains, for example, email addresses.

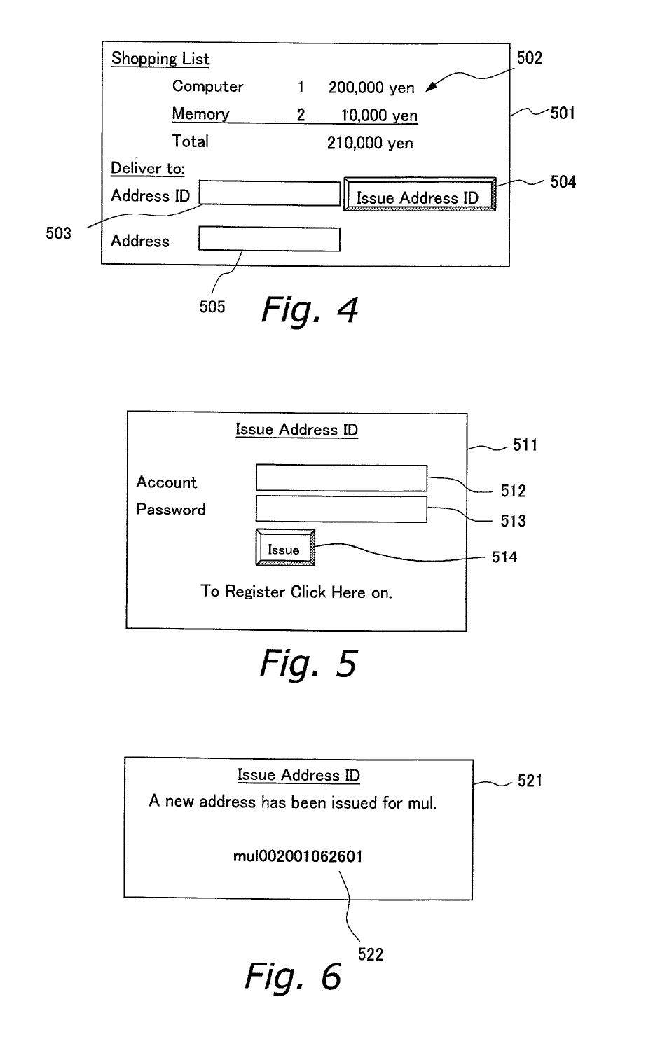

The purchaser 100 accesses an online shopping site of the vendor 200, searches for merchandise he likes, and in cases where he wants to make a purchase, notifies the vendor 200. At the online shopping site of the vendor 200, the merchandise purchase request of the purchaser 100 is received, and a purchase confirmation screen 501 as shown in FIG. 4 is displayed.

The merchandise purchase confirmation screen 501 has a merchandise for purchase field 502 for showing a list of merchandise the purchaser 100 wishes to purchase, a delivery address input field 503, an issue address ID button 504, and an address data input field 505.

The merchandise for purchase field 502 indicates such information as the name of products the purchaser 100 wishes to purchase, as well as quantity, price, and total price.

In cases where there is no need to keep the address data for the delivery address secret from the vendor 200, the purchaser 100, by inputting address data directly into the address data input field 505, can request delivery of merchandise through the vendor 200.

In addition, the address ID for the delivery address that the purchaser 100 wishes to use can be inputted into the delivery address input field 503. In cases where the purchaser 100 has provided personal information to the delivery company 300 and acquired an address ID, by inputting that address ID, the purchaser 100 can designate a delivery address without inputting the address data for that delivery address.

Further, in cases where the purchaser 100 wishes to request the delivery company 300 to issue a new address ID, the purchaser 100 clicks on the issue address ID button 504 of the merchandise confirmation screen 501. The issue address ID button 504 is linked to a web page of the delivery company 300, and an issue address ID request screen 511, as shown in FIG. 5, appears.

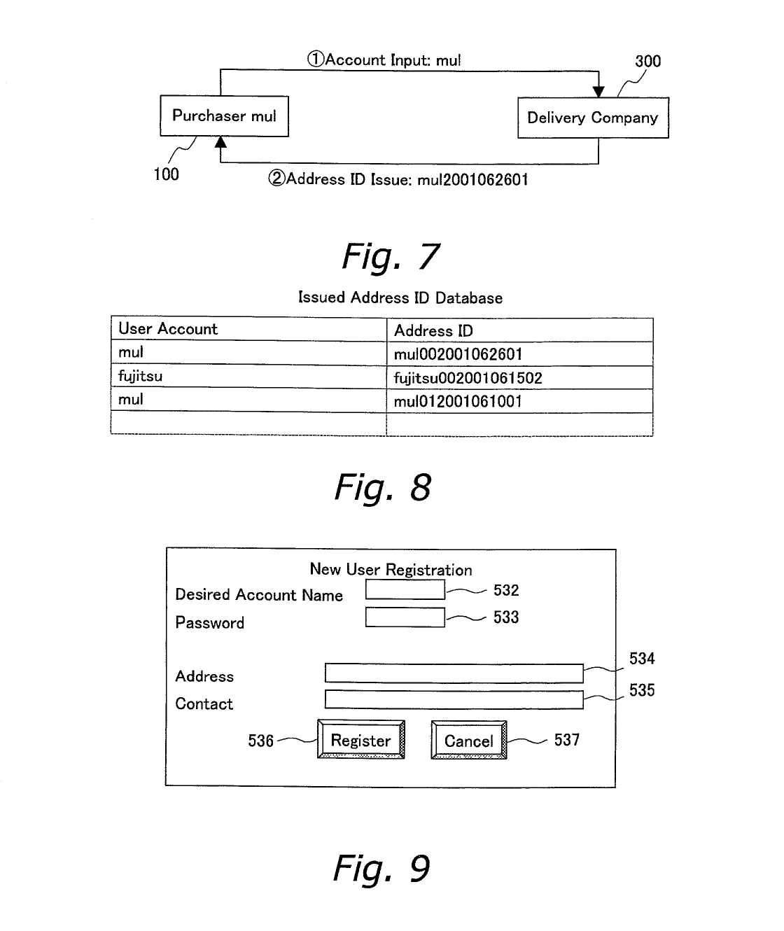

The address ID issue request screen 511 has a user account input field 512, a password input field 513, an issue button 514 and the like. The purchaser 100 inputs the user account set up by the delivery company 300 into the user account input field 512, and inputs his password into the password input field 513, and clicks on the issue button 514. This causes notification of user account by the purchaser 100 to the delivery company 300, as shown in FIG. 7 (#1 of FIG. 7).

The delivery company 300 authenticates the user account based on the user account and password inputted by the purchaser 100 at the address ID issue request screen 511; when authentication is successful, an address ID is issued for this user account (#2 in FIG. 7). Then, the delivery company 300 sends an address ID issue screen 521 to the purchaser 100. This address ID issue screen 521 has an address ID display field 522 for displaying the address ID that has been established.

Simultaneously thereto, the delivery company 300 corresponds issued address IDS with user accounts, managing an issued address ID database, as shown in FIG. 8. This issued address ID database comprises columns for user accounts and address IDS, which contain user accounts and their corresponding address IDs, respectively. In this example, the address ID has a simple structure, of “user account+address number+date+sequence number,” and thus can easily be translated by the delivery company 300 into address data for the delivery address. Further, through the use of existing encryption technology to encrypt address ID, the unauthorized use or alteration of address ID can be prevented; for increased security, use of encryption is preferable. Further, the delivery company 300 acquires information of the vendor 200, and includes in address ID identification information of the vendor 200, facilitating the checking of the party requesting delivery that used the address ID.

In the address ID issue request screen 511 shown in FIG. 5, a new registration button (not shown in the figure) is provided for purchasers 100 not yet registered; by clicking this button, such a new purchaser can register. For example, when a purchaser 100 clicks this new registration request button, a new user registration screen 531 as shown in FIG. 9 is sent from the delivery company 300. The new user registration screen 531 has a desired account input field 532, a password input field 533, an address input field 534, a contact information input field 535, a registration button 536, and a cancel button 537. The purchaser 100 can input his desired user account name and password into the desired account input field 532 and password input field 533, respectively. The system may also be configured so that user accounts and passwords that have been prepared in 20 advance by the delivery company 300 are displayed in the desired account input field 532 and password input field 533, respectively, and the purchaser 100 is able to modify these. In cases where a user account inputted by a purchaser 100 in the desired account input field is already present within the user account data, a message to that effect is displayed, and the purchaser 100 is prompted to make another entry. The address input field 534 and contact information input field 535 are configured for input of, respectively, the purchaser 100's address data and email address and the like.

By completing input in the various input fields of the new user registration screen 531 and clicking on the registration button 536, the purchaser 100 sends the inputted data to the delivery company 300. In cases where the purchaser 100 wishes to cancel new registration, the purchaser 100 clicks on the cancel button 537 to return to the previous screen.

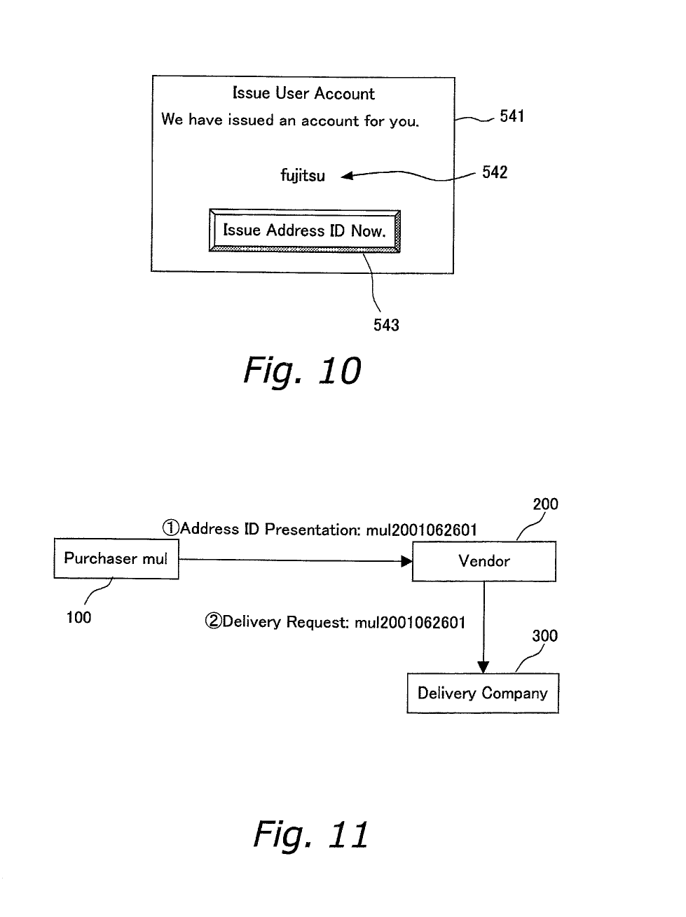

When the delivery company 300 receives data inputted by the purchaser 100 at the new user registration screen 531, it establishes a user account for this purchaser 100, updates the user account database shown in FIG. 3, and sends to the purchaser 100 a user account issue screen 541 as shown in FIG. 10. The user account issue screen 541 contains a user account display field 542 that displays the user account name established for the purchaser 100, and an issue address ID button 543. When the purchaser 100 clicks on the issue address ID button 543, an address ID is established for the user account that has just been established, and an issue address ID screen 521 as shown in FIG. 6 is sent to the purchaser 100; in this manner the purchaser 100 is notified of the address ID established.

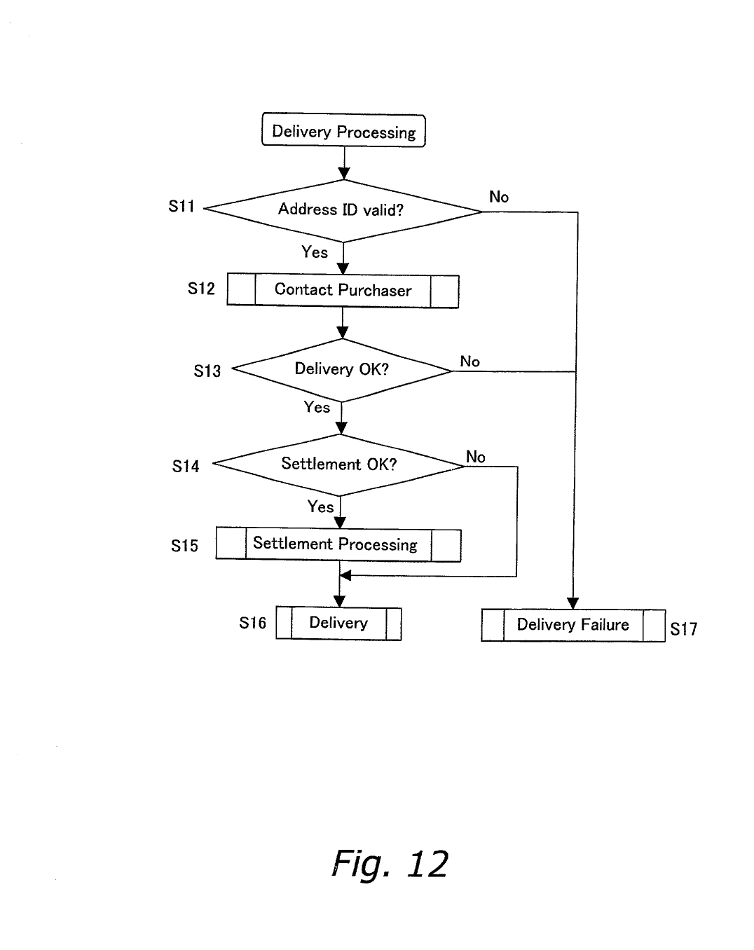

Thus the flow of delivery request processing is as shown in FIG. 11 when the purchaser 100 requests delivery of merchandise using an address ID issued by the delivery company 300. The purchaser 100 notifies the vendor 200 of the address ID issued by the delivery company 300, and requests delivery of merchandise (#1 in FIG. 11). The vendor 200, having accepted the address ID from the purchaser 100, notifies the delivery company 300 of the delivery request, which includes information about the merchandise purchaser 100 chose to purchase and address ID (e.g., mul2001062601) (#2 in FIG. 12).

The delivery company 300, having received delivery request data from the vendor 200, executes delivery processing based on the flowchart shown in FIG. 12.

In Step S11, it is determined whether the address ID included within delivery request data received from the vendor 200 is valid. The delivery company 300 looks up the address ID included within delivery request data received from the vendor 200 in an issued address ID database as shown in FIG. 8, and extracts the corresponding user account. If such an address ID does not exist within the issued address ID database, it is determined that the address ID is not valid, and control proceeds to Step S17. In step S17, the vendor 200 or the purchaser 100 is notified that the address ID is invalid and delivery cannot be made, and delivery failure processing is executed to cancel the delivery request.

If in Step S11 it is determined that the address ID is valid, control proceeds to Step S12. In Step S12, the purchaser 100 is notified that there has been a delivery request from the vendor 200. Specifically, a confirmation email is sent to the purchaser 100 that includes the delivery request from the vendor 200, and the purchaser 100 is prompted to decide whether to accept or not.

In Step S13, it is determined whether the purchaser 100 has approved the delivery request. For example, in cases where the purchaser 100 has replied to confirmation email with an email indicating approval or in cases where in reply to a confirmation email, an email message indicating that approval is not given has not been received within a predetermined length of time, it is determined that the purchaser 100 has given approval, and control proceeds to Step S14. In cases where in reply to a confirmation email the purchaser 100 has sent an email indicating that approval is not given, it is determined that the purchaser 100 has refused the delivery request, and control proceeds to Step S17.

In Step S14, it is determined whether settlement process may be performed by the delivery company 300. In cases where the purchaser 100 has contracted for settlement processing with the delivery company 300, control proceeds to Step S15.

In Step S15, the delivery company 300 executes settlement processing. For example, in cases where the delivery company 300 has been contracted to perform settlement processing by credit card, it executes settlement processing using the credit card number stored in the corresponding user data in the user account database (see FIG. 3), and payment is made to the vendor 200.

In Step S16, address data is extracted from the user account database based on the address ID within the delivery request data. Even in cases where there is more than one address in the same account, as shown in FIG. 8, by having an address number be included in the address ID, delivery addresses can be specified, preventing delivery to the wrong address.

Address ID with Limited Term

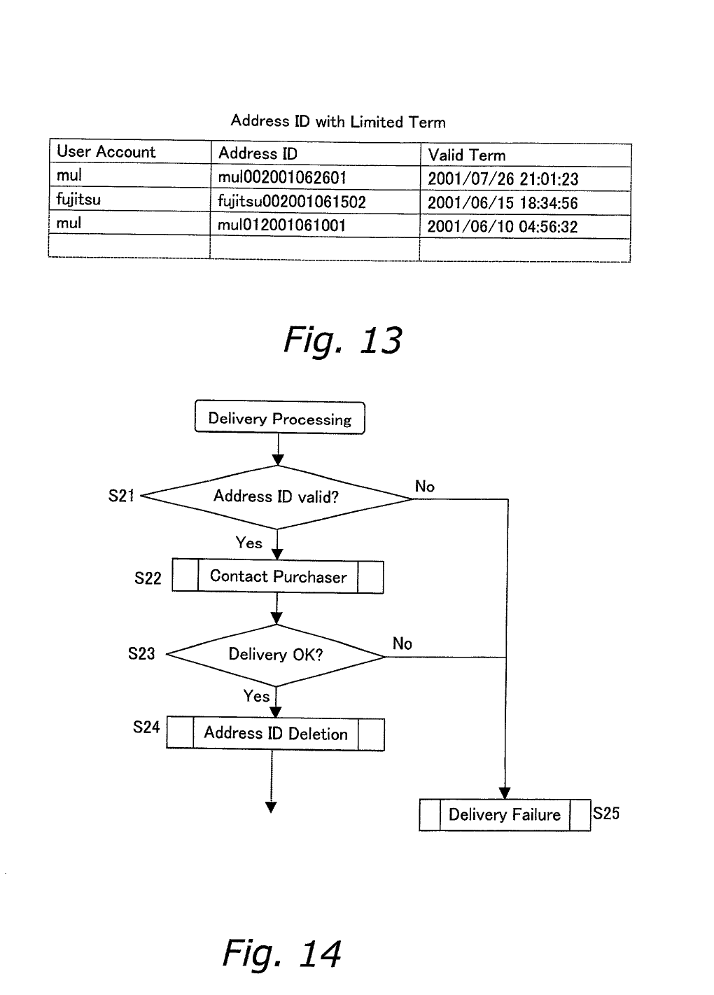

The system can be configured so that when the delivery company 300 issues an address ID to the purchaser 100, it establishes a valid term for that address ID. For example, one conceivable configuration for such an address ID database is as shown in FIG. 13. In this case, this is achieved by adding a column for valid term to the issued address ID database.

In such cases, when the delivery company 300 has received delivery request data from the vendor 200, it looks up the address ID included in the delivery request data in the issued address ID database of FIG. 13, and it is determined whether the valid term has expired or not. If the valid term of the address ID included in the delivery request data has not expired, delivery processing is executed; if the term has expired, delivery failure processing is executed, as delivery is not possible.

The issued address ID database of FIG. 13 may be configured so that address IDs whose valid terms have expired are deleted from the issued address ID database.

Single-Use Address IDs

An address ID issued by the delivery company 300 can be single-use. The processing by the delivery company 300 in such a case is as shown in the flowchart of FIG. 14.

In Step S21, it is determined whether the address ID included in delivery request data received from the vendor 200 is valid. The delivery company 300 looks up the address ID included within delivery request data received from the vendor 200 in an issued address ID database as shown in FIG. 8, and extracts the corresponding user account. If such an address ID does not exist within the issued address ID database, it is determined that the address ID is not valid, and control proceeds to Step S25. In Step S25, the vendor 200 or the purchaser 100 is notified that the address ID is invalid and delivery cannot be made, and delivery failure processing is executed to cancel the delivery request.

If in Step S21 it is determined that the address ID is valid, control proceeds to Step S22. In Step S22, the purchaser 100 is notified that there has been a delivery request from the vendor 200. Specifically, a confirmation email is sent to the purchaser 100 that includes the delivery request from the vendor 200, and the purchaser 100 is prompted to decide whether to accept or not.

In Step S23, it is determined whether the purchaser 100 has approved the delivery request. For example, in cases where the purchaser 100 has replied to confirmation email with an email indicating approval, or in cases where in reply to a confirmation email, an email message indicating that approval is not given has not been received within a predetermined length of time, it is determined that the purchaser 100 has given approval, and control proceeds to Step S24. In cases where in reply to a confirmation email the purchaser 100 has sent an email indicating that approval is not given, it is determined that the purchaser 100 has refused the delivery request, and control proceeds to Step S25.

In Step S24, the corresponding address ID is deleted from the issued ID database. Then, delivery processing is executed in a manner similar to Steps S14 through S16 of FIG. 12.

Because in these cases, once a request for delivery of merchandise using an address ID is processed, that address ID is deleted, unauthorized use of an address ID can be prevented, and even in cases of cracking or other illegal access into computers, the amount of personal information stolen, including address data, is minimized.

In addition, the system may be configured so that the purchaser 100 from time to time requests the delivery company 300 to delete the appropriate address ID from the issued address ID database. In such cases, the delivery company 300 deletes the appropriate address ID from the issued address ID database in response to a request from the purchaser 100.

Purchase Benefits

Benefits can be awarded to the purchaser 100 depending on the number of times the purchaser 100 has designated the delivery company 300 in a delivery request. In such cases, as shown in FIG. 15, a column for number of deliveries is added to the user account database. Each time a delivery is made to an address within the account data, the value in purchaser 100's account data for number of times of delivery will be increased by one.

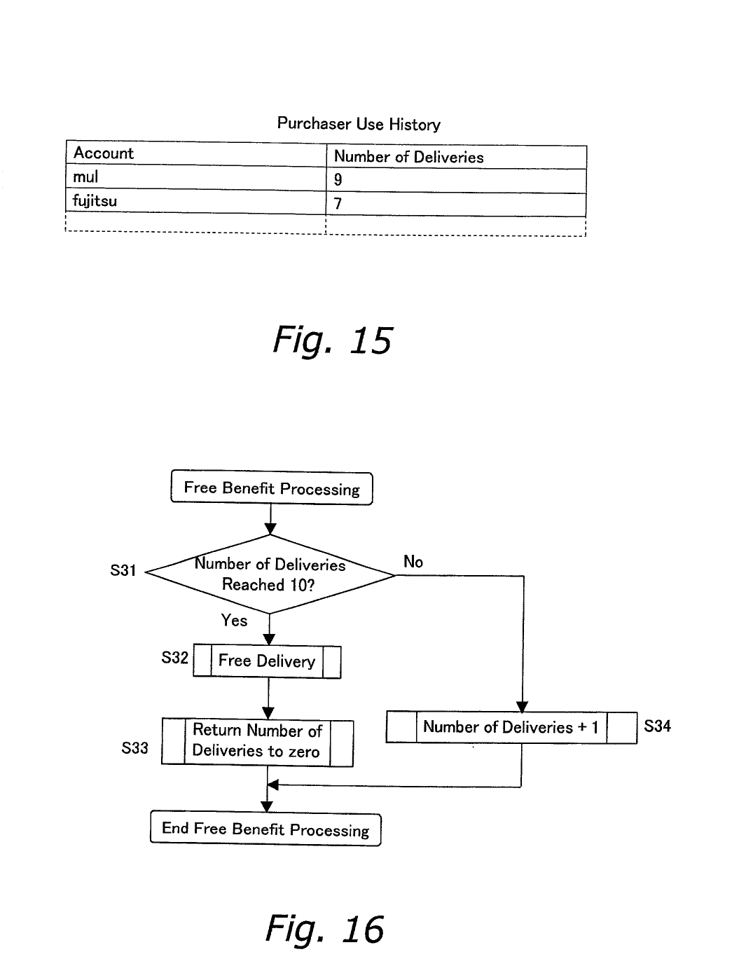

An explanation based on the flowchart of FIG. 16 will be given of cases where there exists a contract between the purchaser 100 and the delivery company 300 stipulating that for every ten times a purchaser uses this delivery company 300, that purchaser will receive one free delivery.

When delivery request data has been received from the vendor 200, the user account data within that delivery request data is looked up, and the number of deliveries is extracted. In Step S31, it is determined whether the extracted number of deliveries for the user account has reached ten. If it is determined that ten has not been reached, control proceeds to Step S34.

In Step S34, the number of deliveries in the user account is raised by one, and this free benefit processing is completed.

If in Step S31 it is determined that the number of deliveries in the user account has reached ten, control proceeds to Step S32. In Step S32, the delivery charge is set at “no charge,” and delivery processing is executed. For example, in cases where the purchaser 100 has contracted the delivery company 300 to process settlement by credit card, the delivery charge is subtracted during settlement processing.

In Step S33, the number of deliveries in the appropriate user account in the user account database is returned to zero, the user account database is updated, and this free benefit processing is completed.

Other possible benefits to be given to the purchaser 100 include a set discount when the amount of charges at the delivery company 300 reach a certain amount, or discount of a certain amount in proportion to the amount of time elapsed since account opening.

Benefits Awarded to Vendor

The system may be configured so that the delivery company 300 awards benefits to the vendor 200 based on the number of times the vendor 200 has issued a delivery request to the delivery company 300.

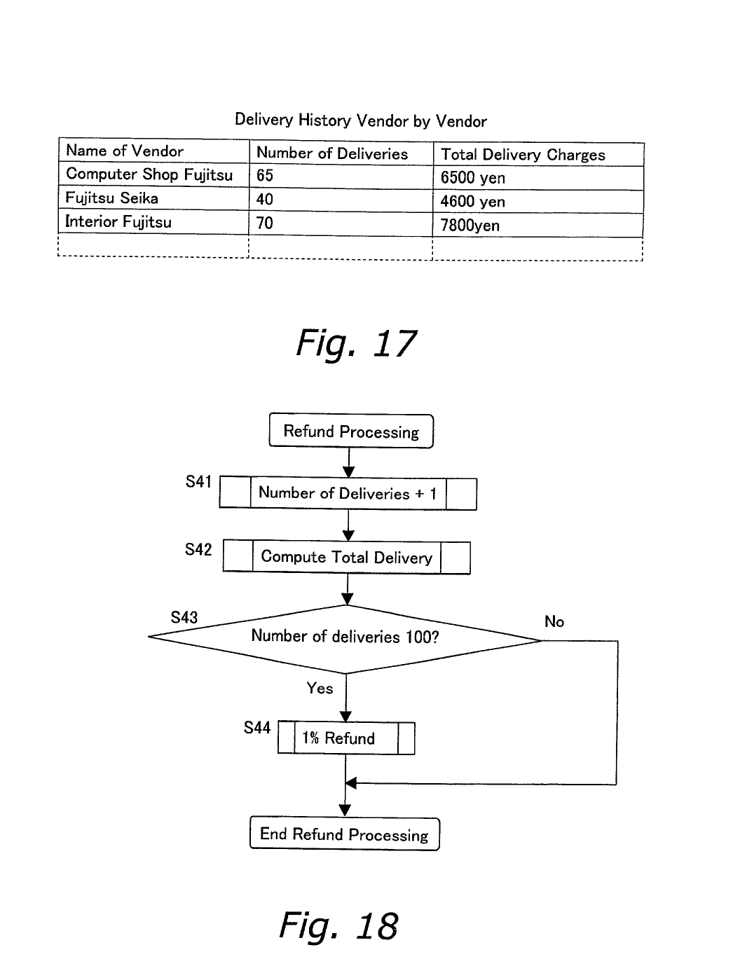

In such a case, for example, the delivery company 300 manages a delivery history database as shown in FIG. 17, and keeps account of the number of deliveries and total delivery charges.

When delivery request data has arrived from the vendor 200, the delivery history database is updated, with number of delivery times increased by one and the new delivery charges added to the total delivery charges. Rules can be set up in advance so that benefits are given to the vendor 200 by the delivery company 300 in proportion to the number of deliveries and total delivery charges. An example is a case where a contract between the delivery company 300 and the vendor 200 stipulates that for each 100 deliveries payment will be made of 1% of the delivery charges therefor; an explanation of such an example will be given based on the flowchart of FIG. 18.

When the delivery company 300 has received delivery request data from the vendor 200, in Step S41, the number of deliveries for that vendor 200 is increased by one.

In Step S42, the current delivery charges are added to the total delivery charges for the vendor 200, and the delivery history database is updated.

In Step S43, it is determined whether the number of deliveries has reached 100. If it is determined that the number of deliveries has reached 100, control proceeds to Step S44. In Step S44, processing is executed to refund to the vendor 200 an amount equivalent to 1% of the total delivery charges. Specifically, the system can be configured so that the appropriate amount is deducted from the invoice for delivery charges to the vendor 200, or so that the appropriate amount is transferred into a bank account of the vendor 200. Then, the number of deliveries and total delivery charges are returned to zero, and this refund processing ends.

Other possible benefits given to the vendor 200 include refunds when the number of users reaches a predetermined number, or refunds based on the number of items delivered.

With the present invention, a purchaser can purchase and request delivery of merchandise without informing the retailer of his address; for example, a purchaser can use an online shopping site with peace of mind. In addition, by providing personal data to a delivery company that will deliver the purchased merchandise, a purchaser can receive benefits from the delivery company.

The merchandise vendor can anticipate an increase in sales due to increased purchaser traffic, and, because it will no longer have to manage purchasers' personal data, it will be able to reduce costs for protecting such purchasers' personal data.

The delivery company, by managing the personal data of merchandise purchasers, can broaden the range of services it provides to users, and offer new services such as settlement processing.

While only selected embodiments have been chosen to illustrate the present invention, to those skilled in the art it will be apparent from this disclosure that various changes and modifications can be made herein without departing from the scope of the invention as defined in the appended claims. Furthermore, the foregoing description of the embodiments according to the present invention is provided for illustration only, and not for the purpose of limiting the invention as defined by the appended claims and their equivalents.

What is claimed is:

1. An address data management method comprising the steps of:
acquiring address data from a purchaser wishing to purchase and have merchandise delivered, said address data comprising delivery address;
establishing a unique address ID for said address data, said address ID being invulnerable to reverse translation by a third party into said address data, and notifying said purchaser thereof;
managing a correspondence table indicating correspondence between said address data and address ID;
accepting delivery request data generated by a vendor of said merchandise based upon a delivery request from the said purchaser, said purchaser having given said address ID as delivery address;
looking up the address ID in said delivery request in said correspondence table, and extracting corresponding address data; and
executing delivery processing of said article based on said extracted address data.

2. An address data management method according to claim 1, wherein at the elapse of a set length of time following establishment of said address ID, the corresponding address ID in said correspondence table is deleted.

3. An address data management method according to claim 1, wherein an address ID corresponding to address data for which delivery processing has been executed a predetermined number of times is deleted from said correspondence table.

4. An address data management method according to claim 3, wherein an address ID corresponding to address data for which delivery processing has been executed once is deleted from said correspondence table.

5. An address data management method according to claim 1, further including the step of accepting from said purchaser instructions to make said address ID invalid, and deleting the corresponding address ID in said table.

6. An address data management method comprising the steps of:
acquiring address data from a purchaser wishing to purchase and have merchandise delivered, said address data comprising delivery address;
establishing a unique user account for identifying said purchaser and notifying said purchaser thereof;
managing a correspondence table showing the correspondence between said address data and user accounts;
in response to an inquiry from a vendor of merchandise that said purchaser wishes to purchase and have delivered, authenticating said purchaser using said purchaser's user account, establishing an address ID invulnerable to reverse translation to said address data by a third party, and notifying said vendor of said address ID;
accepting delivery request data generated by a vendor of said merchandise that includes said address ID;
executing delivery processing of said article based on address data corresponding to said address ID.

7. An address data management method according to claim 6, further comprising the steps of:
computing use points for said user account each time delivery processing is executed; and
awarding benefits to said user account based on the accumulated total of said use points.

8. An address data management method according to claim 6, further comprising the step of transferring said delivery request data to said purchaser when delivery request data has been received from said vendor, and accepting confirmation information from said purchaser.

9. An address data management method according to claim 6, further comprising the step of determining whether the address ID included in delivery request data received from said vendor is valid, and deciding whether to execute delivery processing of said article based on the results of said determination.

10. An address data management method according to claim 6, further comprising the step of setting up benefits in advance to award to said vendor each time delivery request data is received from said vendor.

11. An address data management method according to claim 6, further comprising the steps of:
acquiring information relating to settlement method by said purchaser; and
settling accounts with said vendor based on information relating to settlement method upon receipt of delivery request data from said vendor.

12. An address data management system comprising:
address data acquisition means for acquiring address data from a purchaser wishing to purchase and have merchandise delivered, said address data comprising delivery address;
address ID establishment means for establishing a unique address ID for said address data, said address ID being invulnerable to reverse translation by a third party into said address data, and notifying said purchaser thereof;
correspondence table management means for managing a correspondence table indicating correspondence between said address data and address ID;
delivery request acceptance means for accepting delivery request data generated by a vendor of said merchandise based upon a delivery request from the said purchaser, said purchaser having given said address ID as delivery address;
delivery processing means for looking up the address ID in said delivery request in said correspondence table, extracting the corresponding address data, and executing delivery processing of said article based on said extracted address data.

13. An address data management system method according to claim 12, wherein said correspondence table management means deletes the corresponding address ID in said correspondence table when a set length of time has elapsed following establishment of said address.

14. An address data management system according to claim 12, wherein said correspondence table management means deletes an address ID corresponding to address data for which delivery processing has been executed a predetermined number of times.

15. An address data management system according to claim 12, wherein said correspondence table management means deletes an address ID corresponding to address data for which delivery processing has been executed once.

16. An address data management system according to claim 12, wherein said correspondence table management means accepts from said purchaser instructions to make said address ID invalid, and deletes the corresponding address ID in said table.

17. An address data management system comprising:
address data acquisition means for acquiring address data comprising delivery address from a purchaser wishing to purchase and have merchandise delivered;
user account establishment means for establishing a unique user account for identifying said purchaser and notifying said purchaser thereof;
correspondence table management means for managing a correspondence table indicating correspondence between said address data and user account;
address ID establishment means for, in response to an inquiry from a vendor of merchandise that said purchaser wishes to purchase and have delivered, authenticating said purchaser using said purchaser's user account, establishing an address ID invulnerable to reverse translation to said address data by a third party, and notifying said vendor of said address ID;
delivery request acceptance means for accepting delivery request data generated by a vendor of said merchandise, that includes said address ID; and
delivery processing means for executing delivery processing of said article based on address data corresponding to said address ID.

18. An address data management system according to claim 17, further comprising:
use point management means for adding use points for said user account each time delivery processing is executed; and
benefit presentation means for awarding benefits to said user account based on the accumulated total of said use points.

19. An address data management system according to claim 17, further comprising request confirmation means for transferring said delivery request data to said purchaser when delivery request data has been received from said vendor, and accepting confirmation information from said purchaser.

20. An address data management system according to claim 17, further comprising address ID determination means for determining whether the address ID included in delivery request data received from said vendor is valid, and deciding whether to execute delivery processing of said article based on the results of said determination.

21. An address data management system according to claim 17, further comprising vendor benefit establishment means for establishing benefits in advance to award to said vendor each time delivery request data is received from said vendor.

22. An address data management system according to claim 17, further comprising:
settlement information acquisition means for acquiring information relating to settlement method from said purchaser; and
settlement means for settling accounts with said vender based on information relating to said settlement method, upon receipt of delivery request data from said vendor.
